(19) United States
(12) Patent Application Publication
(10) Pub. No.: US 2024/0218184 A1
(43) Pub. Date: Jul. 4, 2024

(54) ASPHALT COMPOSITION

(71) Applicant: KAO CORPORATION, Tokyo (JP)

(72) Inventor: Machiko IE, High Point, NC (US)

(73) Assignee: KAO CORPORATION, Tokyo (JP)

(21) Appl. No.: 18/289,136

(22) PCT Filed: Aug. 27, 2021
(86) PCT No.: PCT/US2021/047840

§ 371 Date: Nov. 1, 2023

(51) Int. Cl. C08L 95/00; E01C 7/26

(52) U.S. Cl. CPC C08L 95/00; E01C 7/265

(57) ABSTRACT

An asphalt composition containing asphalt (A) and a composite resin (B), wherein the composite resin (B) contains a polyester resin (b1) unit and a vinyl-based polymer (b2) unit bonded via a covalent bond, wherein the polyester resin (b1) unit contains a structural unit derived from an alcohol component and a structural unit derived from a carboxylic acid component, and the vinyl-based polymer (b2) unit contains a structural unit derived from styrene.

### FIELD OF THE INVENTION

The present invention relates to an asphalt composition.

### BACKGROUND OF THE INVENTION

To pave automobile roads, car parking spaces, freight yards, sidewalks, and the like, asphalt pavement containing an asphalt mixture is conveniently laid down, and the period of time from the start of pavement work to the resume of transit service is minimized. The asphalt pavement forms a road surface including an asphalt mixture having an aggregate bound by asphalt, hence providing the paved road with the favorable hardness and durability.

US 2019/0233647 A (PTL 1) describes an asphalt composition that is excellent in storage stability at high temperature and can provide a pavement surface with excellent dry strength. The said asphalt composition contains asphalt, a polyester resin, and a dispersant.

U.S. Pat. No. 10,392,509 (PTL 2) describes a high-grade asphalt composition having a waterproof function.

### SUMMARY OF INVENTION

The present invention relates to an asphalt composition containing asphalt (A) and a composite resin (B), wherein the composite resin (B) contains a polyester resin (b1) unit and a vinyl-based polymer (b2) unit bonded via a covalent bond, wherein the polyester resin (b1) unit contains a structural unit derived from an alcohol component and a structural unit derived from a carboxylic acid component, while the vinyl-based polymer (b2) unit contains a structural unit derived from styrene.

### DETAILED DESCRIPTION OF THE INVENTION

In the asphalt composition described in PTL 1, the mixture of asphalt and polyester resin might show the presence of a small amount of polyester resin precipitate that is formed in the asphalt mixture due to the difference in specific gravities therebetween. The resulting resin precipitation would affect the strength variability of the asphalt mixture (hot mix asphalt).

In the asphalt composition described in PTL 2, also, the strength of the asphalt mixture (hot mix asphalt) shows variability in some cases.

At the asphalt pavement construction site, the asphalt composition is stored in a tank at high temperature for a prolonged period of time. The asphalt mixture is also stored in silos for a prolonged period of time. Under these circumstances, improvements of the storage stability of the asphalt composition are required.

The present invention relates to an asphalt composition that shows much improved storage stability, in which the resulting asphalt mixture remains homogeneous for a prolonged period at high temperature. Furthermore, the asphalt composition of this invention provides improved resistance to fuel/oil degradation of the asphalt pavement.

The present invention relates to the following items [1] to [14].

[1] An asphalt composition comprising asphalt (A) and a composite resin (B),
wherein the composite resin (B) contains a polyester resin (b1) unit and a vinyl-based polymer (b2) unit bonded via a covalent bond,
wherein the polyester resin (b1) unit contains a structural unit derived from an alcohol component and a structural unit derived from a carboxylic acid component,
and the vinyl-based polymer (b2) unit contains a structural unit derived from styrene.

[2] The asphalt composition according to [1], wherein the alcohol component contains an alkylene oxide adduct of bisphenol A.

[3] The asphalt composition according to [1] or [2], wherein the carboxylic acid component contains an aromatic dicarboxylic acid.

[4] The asphalt composition according to any one of [1] to [3], wherein the carboxylic acid component contains succinic acid substituted by an alkenyl group having 2 to 20 carbon atoms.

[5] The asphalt composition according to any one of [1] to [4], wherein the vinyl-based polymer (b2) further contains a structural unit derived from an alkyl (meth)acrylate having an alkyl group having 4 to 22 carbon atoms.

[6] The asphalt composition according to any one of [1] to [5], wherein the composite resin (B) has a molar ratio of the vinyl-based polymer (b2) unit to the polyester resin (b1) unit ((b2)/(b1)) of 10/90 to 45/55.

[7] The asphalt composition according to any one of [1] to [6], wherein the vinyl-based polymer (b2) has a SP value of 9.5 to 10.5.

[8] The asphalt composition according to any one of [1] to [7], wherein the composite resin (B) has a glass transition temperature of 40° C. to 100° C.

[9] The asphalt composition according to any one of [1] to [8], wherein the composite resin (B) has a polydispersity (Mw/Mn) of 4 to 25.

[10] The asphalt composition according to any one of [1] to [9], wherein the composite resin (B) has a hydroxyl value of 10 mgKOH/g to 35 mgKOH/g.

[11] The asphalt composition according to any one of [1] to [10], wherein the composite resin (B) has a softening point of 95° C. to 130° C.

[12] The asphalt composition according to any one of [1] to [11], wherein the asphalt composition has a content of the asphalt (A) of 85 wt. % to 99.5 wt. %.

[13] The asphalt composition according to any one of [1] to [12], wherein the asphalt composition has a content of the composite resin (B) of 0.5 wt. % to 15 wt. %.

[14] The asphalt composition according to any one of [1] to [13], wherein the asphalt (A) has a content of a thermoplastic elastomer of ≤1 wt. %.

### [Asphalt Composition]

The asphalt composition of the present invention contains asphalt (A) and a composite resin (B), wherein the composite resin (B) contains a polyester resin (b1) unit and a vinyl-based polymer (b2) unit bonded via a covalent bond, wherein the polyester resin (b1) unit contains a structural unit derived from an alcohol component and a structural unit derived from a carboxylic acid component, while the vinyl-based polymer (b2) unit contains a structural unit derived from styrene.

The present inventors have found that the aforementioned issues can be solved by using an asphalt composition containing asphalt and a particular composite resin.

While the mechanism of the action of the effects of the present invention is not completely clear, it is hypothesized that the improved storage stability is achieved by the polyester resin unit and the vinyl-based polymer unit having affinity to both the asphalt and the polyester resin unit, being contained in a composite resin via covalent bonding, thus enhancing the stability of the interface between the asphalt and the polyester resin unit.

The definitions and the like of the terms used in the description herein will be shown below.

In the description herein, the carboxylic acid component of the polyester resin includes not only a compound thereof but also an anhydride and an alkyl ester of a carboxylic acid (for example, the alkyl group has 1 to 3 carbon atoms), which generate an acid through decomposition during the reaction.

The term “bisphenol A” means 2,2-bis(4-hydroxyphenyl)propane.

The term “(meth)acrylic acid” means at least one kind selected from methacrylic acid and acrylic acid, which is similarly applied to a “(meth)acrylate” and a “(meth)acryloyl group”.

The terms “solubility parameter value” and “SP value” in the description herein are values calculated according to the method described in Polymer Engineering and Science, February 1974, Vol. 14, No. 2, Robert F. Fedors. pp. 147-154.

### <Asphalt>

The asphalt composition of the present invention contains asphalt.

The asphalt used may be various kinds of asphalt. Examples thereof include neat asphalt, which is petroleum asphalt for pavement, and modified asphalt.

The neat asphalt means a residual bituminous substance obtained by subjecting a crude oil to an atmospheric distillation equipment, a reduced-pressure distillation equipment, or the like.

Examples of the modified asphalt include blown asphalt; and a polymer-modified asphalt that is modified with a polymeric material, such as a thermoplastic elastomer or a thermoplastic resin (which may be hereinafter referred to as a “polymer-modified asphalt”). The blown asphalt means asphalt obtained in such a manner that a mixture of neat asphalt and a heavy oil is heated and then oxidized by blowing air therein.

The asphalt is preferably selected from neat asphalt and polymer-modified asphalt, wherein polymer-modified asphalt is more preferred from the standpoint of the durability of the asphalt pavement, and neat asphalt is more preferred from the standpoint of the general versatility.

### (Thermoplastic Elastomer)

Examples of the thermoplastic elastomer in the polymer-modified asphalt include at least one polymer selected from a styrene-butadiene block copolymer (which may be hereinafter referred to as “SB”), a styrene-butadiene-styrene block copolymer (which may be hereinafter referred to as “SBS”), a styrene-butadiene random copolymer (which may be hereinafter referred to as “SBR”), a styrene-isoprene block copolymer (which may be hereinafter referred to as “SI”), a styrene-isoprene-styrene block copolymer (which may be hereinafter referred to as “SIS”), a styrene-isoprene random copolymer (which may be hereinafter referred to as “SIR”), an ethylene-vinyl acetate copolymer, an ethylene-acrylate ester copolymer, a styrene-ethylene-butylene-styrene copolymer, a styrene-ethylene-propylene-styrene copolymer, a polyurethane based thermoplastic elastomer, a polyolefin based thermoplastic elastomer, an isobutylene-isoprene copolymer, polyisoprene, polychloroprene, synthetic rubber other than these materials, and natural rubber.

Among these, the thermoplastic elastomer is preferably selected from SB, SBS, SBR, SI, SIS, SIR, and an ethylene-acrylate ester copolymer, more preferably selected from SB, SBS, SBR, SI, SIS, and SIR, and further preferably selected from SBR and SBS, from the standpoint of the durability of the asphalt pavement.

The content of the thermoplastic elastomer in the polymer-modified asphalt is preferably ≤3 wt. %, more preferably ≤1.5 wt. %, and further preferably ≤1 wt. %, from the standpoint of the durability of the asphalt pavement.

The total content of the asphalt in the asphalt composition is preferably ≥85 wt. %, more preferably ≥90 wt. %, and further preferably ≥95 wt. %, from the standpoint of the asphalt performance, and is ≤99.5 wt. %, more preferably ≤99 wt. % or less by mass, and further preferably ≤98 wt. %, from the standpoint of the storage stability.

### <Composite Resin (B)>

The asphalt composition of the present invention further contains a composite resin (B), wherein the composite resin (B) contains a polyester resin (b1) unit and a vinyl based polymer (b2) unit bonded via a covalent bond, wherein the polyester resin (b1) unit contains a structural unit derived from an alcohol component and a structural unit derived from a carboxylic acid component, and the vinyl based polymer (b2) unit contains a structural unit derived from styrene. The composite resin (B) may be used alone or as a combination of two or more kinds thereof.

[Polyester Resin (b1)]

The polyester resin (b1) contains a structural unit derived from an alcohol component and a structural unit derived from a carboxylic acid component. The polyester resin (b1) can be obtained by subjecting a carboxylic acid component and an alcohol component to polycondensation reaction. The alcohol component and the carboxylic acid component will be described below.

The polyester resin (b1) may be used alone or as a combination of two or more types thereof.

### (Alcohol Component)

Examples of the alcohol component include an aliphatic diol, an aromatic diol, and a trihydric or higher polyhydric alcohol. The alcohol component may be used alone or as a combination of two or more kinds thereof.

The alcohol component preferably contains a dihydric alcohol, such as an aliphatic diol and an aromatic diol.

The alcohol component preferably contains an alkylene oxide adduct of bisphenol A (2,2-bis(4-hydroxyphenyl)propane), and more preferably contains an alkylene oxide adduct of bisphenol A represented by the following formula (I).

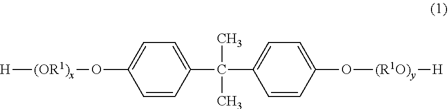

In the formula (I), ORI and RIO each represent an alkylene oxide; R1 represents an alkylene group having 2 or 3 carbon atoms; and x and y each represent a positive number showing the average addition molar number of the alkylene oxide, provided that the sum of x and y is preferably ≥1, more preferably ≥1.5, and further preferably ≥2, and is preferably ≤16, ≤ preferably ≤8, and further preferably ≤4.

Examples of the alkylene oxide adduct of bisphenol A represented by the formula (I) include a propylene oxide adduct of bisphenol A and an ethylene oxide adduct of bisphenol A. Among these, a propylene oxide adduct of bisphenol A alone and a combination of a propylene oxide adduct of bisphenol A and an ethylene oxide adduct of bisphenol A are preferred.

The content of the alkylene oxide adduct of bisphenol A in 100% by mol of the alcohol component is preferably ≥65% by mol, more preferably ≥75% by mol, further preferably ≥90% by mol, and still further preferably 100% by mol, from the standpoint of the achievement of the excellent dry strength.

In the case where the alcohol component contains the combination of a propylene oxide adduct of 2,2-bis(4-hydroxyphenyl)propane and an ethylene oxide adduct of 2,2-bis(4-hydroxyphenyl)propane, the molar ratio (propylene oxide adduct of bisphenol A)/(ethylene oxide adduct of bisphenol A) is preferably ≥40/60, more preferably ≥50/50, and further preferably ≥60/40, from the standpoint of enhancing the melt dispersibility in the asphalt, achieving excellent dry strength, and is preferably ≤90/10, more preferably ≤80/20, and further preferably ≤75/25, from the standpoint of enhancing further the melt dispersibility in the asphalt.

The alcohol component may contain a monohydric alcohol for modifying the properties.

### (Carboxylic Acid Component)

The carboxylic acid component preferably contains a dibasic carboxylic acid compound, such as an aliphatic dicarboxylic acid and an aromatic dicarboxylic acid.

Among these, the carboxylic acid component preferably contains an aromatic dicarboxylic acid, more preferably one or more kind selected from terephthalic acid and isophthalic acid, and further preferably terephthalic acid, from the standpoint of the dry strength of the asphalt pavement.

The content of one or more kind selected from terephthalic acid and isophthalic acid in the carboxylic acid component is preferably ≥50% by mol, more preferably ≥60% by mol, further preferably ≥80% by mol, and still further preferably 100% by mol, based on 100% by mol of the carboxylic acid component, from the standpoint of the dry strength of the asphalt pavement containing the composite resin.

Examples of the other carboxylic acid components include an aromatic dicarboxylic acid other than terephthalic acid and isophthalic acid, an aliphatic dicarboxylic acid, a trihydric or higher polybasic carboxylic acid, and acid anhydrides and alkyl (having 1 to 3 carbon atoms) esters of these carboxylic acids. The carboxylic acid component may be used alone or as a combination of two or more kinds thereof.

The number of carbon atoms of the main chain of the aliphatic dicarboxylic acid is preferably in 4-10 range, more preferably in 4-8 range, and further preferably in 4-6 range, from the standpoint of the dry strength enhancement.

Specific examples thereof include oxalic acid, malonic acid, maleic acid, fumaric acid, citraconic acid, itaconic acid, glutaconic acid, succinic acid, adipic acid, suberic acid, azelaic acid, sebacic acid, and dodecanedioic acid.

Examples of the aliphatic dicarboxylic acid also include succinic acid substituted by an alkyl group having 1-20 carbon atoms or an alkenyl group having 2-20 carbon atoms, such as dodecylsuccinic acid, dodecenylsuccinic acid, and octenylsuccinic acid, and succinic acid substituted by an alkenyl group having 2-20 carbon atoms is preferred.

The number of carbon atoms of the alkenyl group is 2-20, is preferably ≥9, and more preferably ≥10, and is preferably ≤18, and more preferably ≤14, from the standpoint of the melt dispersibility improvement in the asphalt.

The alkenyl group may be a linear chain or a branched chain and is preferably a branched chain from the standpoint of the dry strength of the asphalt pavement.

The alkenylsuccinic acid is preferably formed of two or more kinds thereof from the standpoint of the melt dispersibility in the asphalt, the dry strength of the asphalt pavement. The term “kind” herein is originated from the alkenyl group, and examples of different kinds of alkenylsuccinic acids include those having alkenyl groups having different chain lengths, i.e., numbers of carbon atoms, and structural isomers thereof.

In the aliphatic dicarboxylic acid, fumaric acid and succinic acid substituted by an alkyl group having 1-20 carbon atoms or an alkenyl group having 2-20 carbon atoms are preferred, and succinic acid substituted by an alkenyl group having 2-20 carbon atoms is more preferred, from the standpoint of the melt dispersibility improvement in the asphalt

In the case where the carboxylic acid component as a raw material monomer of the polyester resin contains an aliphatic dicarboxylic acid, the content of the aliphatic dicarboxylic acid is preferably ≥1% by mol, more preferably ≥5% by mol, and further preferably ≥10% by mol, and is preferably ≤40% by mol, more preferably ≤35% by mol, and further preferably ≤30% by mol, based on 100% by mol of the carboxylic acid component, from the standpoint of the enhancement of the dry strength.

Examples of the tribasic or higher polybasic carboxylic acid include trimellitic acid, 2,5,7-naphthalenetricarboxylic acid, pyromellitic acid, and acid anhydrides thereof, and trimellitic acid and an acid anhydride thereof are preferred from the standpoint of the further enhancement of the dry strength.

In the case where the carboxylic acid component contains a tribasic or higher polyhydric carboxylic acid, the content of the tribasic or higher polyhydric carboxylic acid is preferably 1% or more by mol, more preferably ≥3% by mol, and further preferably ≥5% by mol, and is preferably ≤30% by mol, more preferably ≤20% by mol, and further preferably ≤15% by mol, based on 100% by mol of the carboxylic acid component, from the standpoint of the enhancement of the dry strength.

The carboxylic acid component may contain a monobasic carboxylic acid compound for modifying the properties.

(Molar Ratio of Structural Unit Derived from Carboxylic Acid Component to Structural Unit Derived from Alcohol Component)

The molar ratio of the structural unit derived from the carboxylic acid component to the structural unit derived from the alcohol component (carboxylic acid component/alcohol component) is preferably ≥0.7, and more preferably ≥0.8, and is preferably ≤1.5, more preferably ≤1.3, further preferably ≤1.1, and still further preferably ≤1.0, from the standpoint of the regulation of the hydroxyl value.

[Vinyl Based Polymer (b2)]

The vinyl-based polymer (b2) contains a structural unit derived from styrene. Accordingly, the vinyl-based polymer (b2) is an addition polymer of a raw material monomer containing styrene.

The content of styrene in the raw material monomer of the vinyl-based polymer (b2) is preferably ≥50 wt. %, more preferably ≥65 wt. %, and further preferably ≥70 wt. %, and is ≤100 wt. %, preferably ≤95 wt. %, more preferably ≤90 wt. %, and further preferably ≤85 wt. %.

Examples of the raw material monomer other than styrene include a styrene based compound other than styrene, such as methylstyrene, α-methylstyrene, β-methylstyrene, tert-butylstyrene, chlorostyrene, chloromethylstyrene, methoxystyrene, and styrenesulfonic acid and a salt thereof, a (meth)acrylate ester, such as an alkyl (meth)acrylate, benzyl (meth)acrylate, and dimethylaminoethyl (meth)acrylate; an olefin compound, such as ethylene, propylene, and butadiene; a halovinyl compound, such as vinyl chloride; a vinyl ester compound, such as vinyl acetate and vinyl propionate; a vinyl ether compound, such as vinyl methyl ether; a vinylidene halide, such as vinylidene chloride; and N-vinyl compound, such as N-vinylpyrrolidone. Among these, a (meth)acrylate ester is preferred, and an alkyl (meth)acrylate is more preferred.

The number of carbon atoms of the alkyl group in the alkyl (meth)acrylate is preferably ≥1, more preferably ≥4, further preferably ≥10, and still further preferably ≥14, and is preferably ≤24, more preferably ≤22, and further preferably ≤20, from the standpoint of storage stability and fuel resistance.

Examples of the alkyl (meth)acrylate include methyl (meth)acrylate, ethyl (meth)acrylate, (iso)propyl (meth)acrylate, isobutyl or tert-butyl (meth)acrylate, (iso)amyl (meth)acrylate, cyclohexyl (meth)acrylate, 2-ethylhexyl (meth)acrylate, (iso)octyl (meth)acrylate, (iso)decyl (meth)acrylate, (iso)dodecyl (meth)acrylate, (iso)palmityl (meth)acrylate, (iso)stearyl (meth)acrylate, and (iso)behenyl (meth)acrylate. Among these, butyl (meth)acrylate, 2-ethylhexyl (meth)acrylate, and stearyl (meth)acrylate are preferred, 2-ethylhexyl (meth)acrylate is more preferred, and 2-ethylhexyl acrylate is further preferred.

The raw material monomer other than styrene of the vinyl-based polymer (b2) is preferably an alkyl (meth)acrylate having an alkyl group having ≥4 and ≤22 carbon atoms.

The content of the alkyl (meth)acrylate in the raw material monomer of the vinyl-based polymer (b2) is preferably ≥5 wt. %, more preferably ≥10 wt. %, and further preferably ≥15 wt. %, and is preferably ≤50 wt. %, more preferably ≤40 wt. %, and further preferably ≤30 wt. %.

The total content of styrene and the alkyl (meth)acrylate in the raw material monomer of the vinyl-based polymer (b2) is preferably ≥80 wt. %, more preferably ≥90 wt. %, further preferably ≥95 wt. %, and still further preferably 100 wt. %, based on total 100 wt. % of the raw material monomer.

### [Bi-Reactive Monomer]

The composite resin (B) preferably contains a structural unit derived from a bi-reactive monomer bonded to the polyester resin unit and the vinyl-based polymer unit via covalent bonds. The term “structural unit derived from a bi-reactive monomer” means a unit formed through reaction of the functional group and the unsaturated bond moiety of the bi-reactive monomer.

Examples of the bi-reactive monomer include an addition polymerizable monomer having at least one functional group selected from hydroxy group, carboxy group, epoxy group, primary amino group, and secondary amino group.

Among these, an addition polymerizable monomer having at least one functional group selected from hydroxy group and carboxy group is preferred, and an addition polymerizable monomer having a carboxy group is more preferred, from the standpoint of the reactivity. Examples of the addition polymerizable monomer having a carboxy group include acrylic acid, methacrylic acid, fumaric acid, and maleic acid. Examples of the addition polymerizable monomer having a hydroxy group include 2-hydroxyethyl methacrylate. Among these, acrylic acid and methacrylic acid are preferred, and acrylic acid is more preferred, from the standpoint of the reactivity of both the polycondensation reaction and the addition polymerization reaction.

The amount of the structural unit derived from the bi-reactive monomer is preferably ≥1 part by mol, more preferably ≥5 parts by mol, and further preferably ≥8 parts by mol, and is preferably ≤30 parts by mol, more preferably ≤25 parts by mol, and further preferably ≤20 parts by mol, per 100 parts by mol of the alcohol component of the polyester resin unit of the composite resin.

### [Hydrocarbon Wax]

The composite resin may further contain a structural unit derived from hydrocarbon wax having at least one of a carboxy group and a hydroxy group.

The structural unit derived from the hydrocarbon wax is, for example, hydrocarbon wax bonded to the polyester resin unit via a covalent bond through reaction of the hydroxy group or the carboxy group.

The hydrocarbon wax preferably has at least one of a carboxy group and a hydroxy group. The hydrocarbon wax may have any one or both of a hydroxy group and carboxy group, and preferably has a hydroxy group and a carboxy group.

The hydrocarbon wax may be obtained, for example, through modification of non-modified hydrocarbon wax by a known method. Examples of the raw material of the hydrocarbon wax include paraffin wax, Fischer-Tropsch wax, microcrystalline wax, polyethylene wax, and polypropylene wax. Among these, paraffin wax and Fischer-Tropsch wax are preferred.

Examples of the commercially available product of the hydrocarbon wax having a hydroxy group include “Unilin 700”, “Unilin 425”, and “Unilin 550” (all available from Baker Petrolite Corporation).

Examples of the hydrocarbon wax having a carboxy group include acid-modified hydrocarbon wax.

Examples of the commercially available product of the hydrocarbon wax having a carboxy group include a maleic anhydride modified ethylene-propylene copolymer “HI-WAX 1105A” (available from Mitsui Chemicals, Inc.).

Examples of the commercially available product of the hydrocarbon wax having a hydroxy group and a carboxy group include “Paracohol 6420”, “Paracohol 6470”, and “Paracohol 6490” (all available from Nippon Seiro Co., Ltd.).

The hydroxyl value of the hydrocarbon wax is preferably ≥35 mgKOH/g, more preferably ≥50 mgKOH/g, and further preferably ≥70 mgKOH/g, and is preferably ≤180 mgKOH/g, more preferably ≤150 mgKOH/g, and further preferably ≤120 mgKOH/g.

The acid value of the hydrocarbon wax is preferably ≥1 mgKOH/g, more preferably ≥5 mgKOH/g, and further preferably ≥10 mgKOH/g, and is preferably ≤30 mgKOH/g, more preferably ≤25 mgKOH/g, and further preferably ≤20 mgKOH/g.

The total of the hydroxyl value and the acid value of the hydrocarbon wax is preferably ≥35 mgKOH/g, more preferably ≥40 mgKOH/g, and further preferably ≥60 mgKOH/g, and is preferably ≤210 mgKOH/g, more preferably ≤175 mgKOH/g, and further preferably ≤140 mgKOH/g.

The number average molecular weight of the hydrocarbon wax is preferably ≥500, more preferably ≥600, and further preferably ≥700, and is preferably ≤2,000, more preferably ≤1,700, and further preferably ≤1,500.

The measurement method of the hydroxyl value and the acid value of the hydrocarbon wax is in accordance with the method described in the examples shown later. The number average molecular weight of the hydrocarbon wax is measured by the gel permeation chromatography method using chloroform as a solvent and polystyrene as the standard substance.

The content of the polyester resin unit in the composite resin is preferably ≥40 wt. %, more preferably ≥45 wt. %, and further preferably ≥55 wt. %, and is preferably ≤90 wt. %, more preferably ≤85 wt. %, and further preferably ≤75 wt. %, based on the total amount of the polyester resin unit, the vinyl-based polymer unit, and the structural unit derived from the bi-reactive monomer.

The content of the vinyl-based polymer unit in the composite resin is preferably ≥10 wt. %, more preferably ≥15 wt. %, and further preferably ≥25 wt. %, and is preferably ≤60 wt. %, more preferably ≤55 wt. %, and further preferably ≤45 wt. %, based on the total amount of the polyester resin unit, the vinyl-based polymer unit, and the structural unit derived from the bi-reactive monomer.

The content of the structural unit derived from the bi-reactive monomer in the composite resin is preferably ≥0.1 wt. %, more preferably ≥0.5 wt. %, and further preferably ≥0.8 wt. %, and is preferably ≤10 wt. %, more preferably ≤5 wt. %, and further preferably ≤3 wt. %, based on the total amount of the polyester resin unit, the vinyl-based polymer unit, and the structural unit derived from the bi-reactive monomer.

The molar ratio of the vinyl-based polymer (b2) unit to the polyester resin (b1) unit in the composite resin ((b2)/(b1)) is preferably ≥10/90, and more preferably ≥15/85, and is preferably ≤45/55, more preferably ≤40/60, and further preferably ≤25/75.

The amount of the structural unit derived from the hydrocarbon wax in the composite resin is preferably ≥0.1 part by mass, more preferably ≥0.5 part by mass, and further preferably ≥1 part by mass, and is preferably ≤10 parts by mass, more preferably ≤8 parts by mass, and further preferably ≤6 parts by mass, per 100 parts by mass of the total amount of the polyester resin unit, the vinyl-based polymer unit, and the structural unit derived from the bi-reactive monomer.

The total amount of the polyester resin unit, the vinyl-based polymer unit, the structural unit derived from the bi-reactive monomer, and the structural unit derived from the hydrocarbon wax in the composite resin is preferably ≥80 wt. %, more preferably ≥90 wt. %, and further preferably ≥95 wt. %, may be ≤100 wt. %, and is preferably 100% by mass.

The amounts described above may be calculated based on the ratio of the amounts of the raw material monomers of the polyester resin unit and the vinyl-based polymer unit, the structural units derived from the bi-reactive monomer and the hydrocarbon wax, and the radical polymerization initiator, excluding the dehydration amount through polycondensation of the polyester resin unit and the like. In the case where the radical polymerization initiator is used, the mass of the radical polymerization initiator is included in the vinyl-based polymer unit in calculation.

### [Properties of Composite Resin]

The softening point of the composite resin is preferably ≥95° C., and more preferably ≥100° C., and is preferably ≤130° C., more preferably ≤125° ° C., and further preferably ≤120° C.

The glass transition temperature of the composite resin is preferably ≥40° C., more preferably ≥42° C., and further preferably ≥45° C., and is preferably ≤100° C. or lower, more preferably ≤88° C., and further preferably ≤70° C.

The acid value of the composite resin is preferably ≥1 mgKOH/g, more preferably ≥3 mgKOH/g, and further preferably ≥5 mgKOH/g, and is preferably ≤40 mgKOH/g, more preferably ≤30 mgKOH/g, and further preferably ≤25 mgKOH/g.

The hydroxyl value of the composite resin is preferably ≥10 mgKOH/g, more preferably ≥11 mgKOH/g, and further preferably ≥15 mgKOH/g, and is preferably ≤35 mgKOH/g, more preferably ≤33 mgKOH/g, and further preferably ≤30 mgKOH/g.

The number average molecular weight (Mn) of the composite resin is preferably ≥1,800, more preferably ≥2,000, and further preferably ≥2,200, and is preferably ≤5,000, more preferably ≤4,500, and further preferably ≤4,000.

The weight average molecular weight (Mw) of the composite resin is preferably ≥15,000, more preferably ≥20,000, and further preferably ≥25,000, and is preferably ≤100,000, more preferably ≤80,000, and further preferably ≤60,000.

The polydispersity (Mw/Mn) of the composite resin is preferably 4 or more, more preferably ≥10, and further preferably ≥15, and is preferably ≤25, more preferably ≤23, and further preferably ≤20.

The SP value of the composite resin is preferably ≥9.5 (cal/cm³)^{1/2}, more preferably ≥9.6 (cal/cm³)^{1/2}, and further preferably ≥9.7 (cal/cm³)^{1/2}, and is preferably 10.5 (cal/cm³)^{1/2} or less, more preferably 10.3 (cal/cm³)^{1/2} or less, further preferably ≤10.2 (cal/cm³)^{1/2}, and still further preferably ≤10.1 (cal/cm³)^{1/2}.

The SP value of the polyester resin unit of the composite resin is preferably ≥10.5 (cal/cm³)^{1/2}, more preferably 1≥0.6 (cal/cm³)^{1/2}, and further preferably ≥10.7 (cal/cm³)^{1/2}, and is preferably ≤12.0 (cal/cm³)^{1/2}, more preferably ≤11.5 (cal/cm³)^{1/2}, and further preferably ≤11.2 (cal/cm³)^{1/2}.

The SP value of the vinyl-based polymer unit of the composite resin is preferably ≥9.5 (cal/cm³)^{1/2}, more preferably ≥9.6 (cal/cm³)^{1/2}, and further preferably ≥9.7 (cal/cm³)^{1/2}, and is preferably ≤10.5 (cal/cm³)^{1/2}, more preferably ≤10.3 (cal/cm³)^{1/2}, further preferably ≤10.2 (cal/cm³)^{1/2}, and still further preferably ≤10.1 (cal/cm³)^{1/2}.

The softening point, the glass transition temperature, and the acid value of the composite resin can be appropriately regulated by the kinds and the amounts of the raw material monomers and the production conditions including the reaction temperature, the reaction time, and the cooling rate, and these values can be obtained in accordance with the method described in the examples shown later. In the case where two or more kinds of the composite resins are used in combination, it is preferred that the softening point, the glass transition temperature, and the acid value obtained for the mixture are in the ranges described above.

### [Production Method of Composite Resin]

The composite resin may be produced, for example, by the step A performing polycondensation reaction of the alcohol component and the carboxylic acid component of the polyester resin unit, and the step B performing addition polymerization reaction of the raw material monomer of the vinyl-based polymer unit and the bi-reactive monomer.

In the case where the composite resin has a structural unit derived from the hydrocarbon wax, the polycondensation reaction of the alcohol component and the carboxylic acid component in the step A may be performed, for example, in the presence of the hydrocarbon wax having at least one of a hydroxy group and a carboxy group.

The step B may be performed after the step A, the step A may be performed after the step B, and the step A and the step B may be performed simultaneously.

### (Step A)

The polycondensation in the step A may be performed by using an esterification catalyst, such as tin(II) di(2-ethylhexanoate), dibutyltin oxide, or titanium diisopropylate bis(triethanol aminate), in an amount of 0.01 to 5 parts by mass per 100 parts by mass of total alcohol and carboxylic acid components, and an esterification promoter, such as gallic acid (known as 3,4,5-trihydroxybenzoic acid), in an amount of 0.001 to 0.5 parts by mass per 100 parts by mass of total alcohol and carboxylic acid components.

In the case where a monomer having an unsaturated bond, such as fumaric acid, is used in the polycondensation reaction, a radical polymerization inhibitor may be used depending on necessity in an amount of preferably 0.001 to 0.5 parts by mass per 100 parts by mass of total alcohol and carboxylic acid components. Examples of the radical polymerization inhibitor include 4-tert-butylcatechol.

The temperature of the polycondensation reaction is preferably ≥120° C., more preferably ≥160° C. higher, and further preferably ≥180° C., and is preferably ≤250° C., more preferably ≤245° C., and further preferably ≤240° C. The polycondensation may be performed in an inert gas atmosphere.

### (Step B)

Examples of the polymerization initiator in the addition polymerization reaction include a peroxide, such as di-tert-butyl peroxide, a persulfate, such as sodium persulfate, and an azo compound, such as 2,2′-azobis(2,4-dimethylvaleronitrile).

The amount of the radical polymerization initiator used is preferably ≥1 part by mass and ≤20 parts by mass per 100 parts by mass of the raw material monomer of the vinyl-based polymer unit.

The temperature in the addition polymerization reaction is preferably ≥110° C., and more preferably ≥130° C., and is preferably ≤220° C., more preferably ≤200° C., and further preferably ≤180° C.

It is preferred that a part of the carboxylic acid component is subjected to the polycondensation reaction in the step A, then the step B is performed, and subsequently after adding the remainder of the carboxylic acid component to the polymerization system, the polycondensation reaction of the step A and depending on necessity the reaction with the bi-reactive monomer is further performed. It is preferred that the tribasic or higher polybasic carboxylic acid (such as trimellitic acid) as the carboxylic acid component in the raw material of the polyester resin unit is not added in the first polycondensation reaction of the step A, and is added after performing the step B.

At the time when the reaction rate of the first polycondensation reaction of the step A reaches, for example, ≥90%, the addition polymerization reaction of the step B may be performed in such a manner that the pressure in the system is reduced, and after cooling, the raw material monomer of the vinyl-based polymer unit and the bi-reactive monomer are added dropwise to the system.

The temperature in the dropwise addition of the raw material monomer of the vinyl-based polymer unit and the bi-reactive monomer in the step B is preferably ≥155° C., more preferably ≥157° C., and further preferably ≥160° C., and is preferably ≤190° C., more preferably ≤180° C., and further preferably ≤170° C. The period of time for the dropwise addition of the raw material monomer of the vinyl-based polymer unit and the bi-reactive monomer in the step B is preferably ≥0.5 hour, more preferably ≥1.5 hours, and further preferably ≥2.5 hours, and is preferably ≤5 hours, more preferably ≤4 hours, and further preferably ≤3.5 hours.

After performing the step B, the remainder of the carboxylic acid component as the raw material of the polyester resin unit may be added to the polymerization system, and the polycondensation reaction of the step A and depending on necessity the reaction with the bi-reactive monomer is further performed. The reaction time of the tribasic or higher polybasic carboxylic acid (such as trimellitic acid) is preferably ≥4 hours, more preferably ≥5 hours, and further preferably ≥6 hours, and is preferably ≤8 hours, more preferably ≤7.5 hours, and further preferably ≤7 hours.

The content of the composite resin in the asphalt composition is preferably 0.5% or more by mass, more preferably ≥1 wt. %, and further preferably ≥2 wt. %, from the standpoint of storage stability, and is preferably ≤15 wt. %, more preferably ≤10 wt. %, and further preferably ≤5 wt. %, from the standpoint of asphalt performance.

### [Production Method of Asphalt Composition]

The asphalt composition of the present invention may be produced by mixing the asphalt and the composite resin. Specifically, the asphalt composition may be obtained in such a manner that the asphalt is melted under heating, to which the composite resin is added, and the components are mixed by mixing with an ordinary mixer until the composite resin is uniformly dispersed in the asphalt.

Examples of ordinary mixers include a homogenizer, a dissolver, a paddle mixer, a ribbon mixer, a screw mixer, a planetary mixer, a vacuum counterflow mixer, a roll mill, and a twin-screw extruder.

The mixing temperature of the asphalt and the composite resin is preferably ≥140° C., more preferably ≥150° C., and further preferably ≥160° C., and is preferably ≤230° C., more preferably ≤210° C., and further preferably ≤200° C., from the standpoint of dispersion homogeneity of the composite resin in the asphalt.

The mixing time of the asphalt and the composite resin is preferably ≥1 minute, more preferably ≥10 minutes, and further preferably ≥30 minutes, from the standpoint of the uniform dispersion of the composite resin in the asphalt, and is preferably ≤48 hours, more preferably ≤30 hours, and further preferably ≤24 hours, from the standpoint of the prevention of the thermal degradation of the asphalt composition.

The asphalt composition of the present invention is a binder composition, and for example, can be used for pavement in the form of an asphalt mixture by adding an aggregate to the asphalt composition. Accordingly, the asphalt composition of the present invention is favorable for surface pavement, and particularly favorable for road pavement.

### [Asphalt Mixture]

An asphalt mixture as a preferred use example of the asphalt composition will be described.

The asphalt mixture contains an aggregate and the asphalt composition. Accordingly, the asphalt mixture contains at least an aggregate, the asphalt, and the composite resin.

### <Aggregate>

The aggregate used may be arbitrarily selected, for example, from crushed stone, cobbled stone, ballast, sand, a recycled aggregate, and ceramics. The aggregate used may be any coarse aggregate having a particle diameter of ≥2.36 mm and any fine aggregate having a particle diameter of <2.36 mm, and it is preferred that a coarse aggregate and a fine aggregate are used in combination.

The content of the aggregate in the asphalt mixture is preferably ≥85 wt. %, more preferably ≥90 wt. %, and further preferably ≥92 wt. %, and is preferably ≤98 wt. %, more preferably ≤97 wt. %, and further preferably ≤96 wt. %, based on 100 wt. % of the asphalt mixture, from the standpoint of the durability of the asphalt pavement.

### <Additive>

Various additives that have been commonly used in asphalt mixtures, such as a film forming agent, a thickening stabilizer, and an emulsifier, may be added to the asphalt mixture, in addition to the aggregate, the asphalt, and the composite resin described above.

The total content of the additives is preferably ≤50 wt. %, more preferably ≤25 wt. %, and further preferably ≤5 wt. %, based on 100 wt. % of the asphalt mixture.

### [Production Method of Asphalt Mixture]

The production method of the asphalt mixture is not particularly limited, and the asphalt mixture may be produced by any production method. In general, the asphalt mixture may be produced according to a production method of an asphalt mixture containing an aggregate and asphalt. Specific examples thereof include a method of adding and mixing the asphalt composition in the heated aggregate.

The temperature of the heated aggregate is preferably ≥130° C., more preferably ≥150° C., and further preferably ≥170° C., from the standpoint of the uniform mixing of the materials, and is preferably ≤230° C., more preferably ≤210° C., and further preferably ≤200° ° C., from the standpoint of the prevention of the thermal deterioration of the asphalt.

The mixing temperature of the aggregate and the asphalt composition is preferably ≥130° C., more preferably ≥150° C., and further preferably ≥170° C., from the standpoint of the uniform mixing of the materials, and is preferably ≤230° C., more preferably ≤210° C., and further preferably ≤200° C., from the standpoint of the prevention of the thermal deterioration of the asphalt.

The mixing time of the aggregate and the asphalt composition is not particularly limited, is preferably ≥30 seconds, more preferably ≥1 minute, and further preferably ≥2 minutes, and is preferably ≤2 hours, more preferably ≤1 hour, and further preferably ≤30 minutes.

The production method of the asphalt mixture preferably includes, after mixing the aggregate and the asphalt composition, a step of maintaining the resulting asphalt mixture at the mixing temperature or a temperature higher than the mixing temperature, from the standpoint of the durability of the asphalt pavement.

During the step of maintaining the temperature of the asphalt mixture, the mixture may be further mixed.

The retaining time is preferably ≥0.5 hour, more preferably ≥1 hour, and further preferably ≥1.5 hours, and the upper limit of the time is not particularly limited, and may be, for example, approximately 48 hours.

### [Road Pavement Method]

The asphalt mixture is appropriate for road pavement, and as described above, the asphalt mixture containing the asphalt composition having the aggregate added thereto is used for road pavement.

The road pavement method includes a step of laying down the asphalt mixture on the road to form an asphalt pavement material layer. Specifically, the road pavement method may include a step of mixing the asphalt composition and the heated aggregate to provide the asphalt mixture (step 1), and a step of laying down the asphalt mixture obtained in the step 1 on the road to form an asphalt pavement material layer (step 2). The asphalt pavement material layer is preferably a base layer or a surface layer.

The asphalt mixture may be compacted with known construction equipment and known methods. The compacting temperature in the case where the heated asphalt mixture is used is preferably ≥100° C., more preferably ≥120° C., and further preferably ≥130° C., and is preferably ≤200° C., and more preferably ≤180° C., from the standpoint of the regulation of the void ratio.

The void ratio of the resulting pavement body may be, for example, preferably ≥3%, and more preferably ≥4%, and is preferably ≤8%, and more preferably ≤7.5%.

### EXAMPLES

In Preparation Examples, Production Examples, Examples, and Comparative Examples shown below, the “part” and “%” mean “part by mass”, “% by mass” or “wt. %” respectively unless otherwise indicated.

The property values of the resins were measured and evaluated in the following manner.

### (1) Measurement Method of Softening Point of Resin

1 g of a specimen was extruded from a nozzle having a diameter of 1 mm and a length of 1 mm by applying a load of 1.96 MPa with a plunger under heating at a temperature rise rate of 6° C./min with a flow tester (trade name: CFT-500D, available from Shimadzu Corporation). The descending amount of the plunger of the flow tester was plotted against the temperature, and the temperature at which the half amount of the specimen had flown was designated as the softening point.

### (2) Measurement Method of Glass Transition Temperature of Composite Resin

0.01 to 0.02 g of a specimen weighed on an aluminum pan was heated to 200° C. and cooled from that temperature to 0° C. at a rate of 10° C./min, with a differential scanning calorimeter (trade name: DSC Q20, available from TA Instruments Japan, Inc.). The specimen was then heated at a rate of 10° C./min, and the endothermic peak was measured. The temperature at the intersection point of the extended line of the base line in the temperature range of the endothermic maximum peak temperature or lower and the tangent line showing the maximum gradient from the rising edge of the peak to the apex of the peak was designated as the glass transition temperature (Tg).

### (3) Measurement Method of Acid Value of Composite Resin

The acid value of the composite resin was measured according to the method of JIS K0070:1992, provided that the measurement solvent was changed from the mixed solvent of ethanol and ether to a mixed solvent of acetone and toluene (acetone/toluene=1/1 (volume ratio)).

### (4) Measurement Method of Hydroxyl Value of Composite Resin

The hydroxyl value of the composite resin was measured according to JIS K0070:1992, provided that the measurement solvent was changed from the mixed solvent of ethanol and ether to tetrahydrofuran.

### (5) Measurement Method of Number Average Molecular Weight, Weight Average Molecular Weight, and Polydispersity of Resin

The molecular weight distribution was measured by the gel permeation chromatography (GPC) method in the following manner, and the number average molecular weight (Mn), the weight average molecular weight (Mw), the peak top molecular weight (Mp), and the polydispersity (Mw/Mn) were obtained.

### (5-1) Preparation Method of Specimen Solution

A specimen was dissolved in tetrahydrofuran at 60° C. to make a concentration of 0.5 g/100 mL. Subsequently, the solution was filtered with a PTFE type membrane filter having a pore diameter of 0.2 μm (trade name: DISMIC-25JP, available from Toyo Roshi Kaisha, Ltd.) to remove insoluble matters, to provide a specimen solution.

### (5-2) Measurement Method of Molecular Weight

With the measurement equipment and the columns described below, tetrahydrofuran as an eluent was flown therein at a flow rate of 1 mL/min to stabilize the columns in a thermostat chamber at 40° C. 100 μL of the specimen solution obtained in the item (5-1) was injected thereto to perform the measurement. The molecular weight of the specimen was calculated based on the calibration curve provided in advance.
Measurement equipment: HLC-8320GPC (available from Tosoh Corporation)
Analysis columns: GMHXL+G3000HXL (available from Tosoh Corporation)

The calibration curve was prepared with several kinds of monodisperse polystyrene “A-500” (5.0×10²), “A-1000” (1.01×10³), “A-2500” (2.63×10³), “A-5000” (5.97×10³), “F-1” (1.02×10³), “F-2” (1.81×10⁴), “F-4” (3.97×10⁴), “F-10” (9.64×10⁴), “F-20” (1.90×10⁵), “F-40” (4.27×10⁵), “F-80” (7.06×10⁵), “F-128” (1.09×10⁶) (all available from Tosoh Corporation) as the standard specimen. The numerals in parentheses show the molecular weights.

### (6) Calculation Method of SP Value of Polyester Resin Unit, Vinyl Based Polymer Unit, and Entire Composite Resin

The solubility parameters (SP values) of the polyester resin unit, the vinyl-based polymer unit, and the entire composite resin were calculated by the method by Fedors, et al., (Polym. Eng. Sci., 14(2), 147 (1974)).

### (7) Measurement Method of Glass Transition Temperature of Vinyl Based Polymer Unit

During the production process of the composite resin, the unreacted monomer of the vinyl based polymer unit was removed at 8.3 kPa, and then 10 g of the product was sampled. For removing the unreacted alcohol monomer and carboxylic acid monomer, 50 g of ethanol was mixed therein, and the insoluble matter was collected by filtration under reduced pressure. The insoluble matter was dried at ordinary temperature under reduced pressure for one day or more, and then measured for the glass transition temperature of the vinyl-based polymer unit according to the section “Measurement Method of Glass Transition Temperature of Composite Resin” above.

### Production Example 1

### (Production of Composite Resin A-1)

The alcohol components and the carboxylic acid components shown in Table 1 were placed in a four-neck flask having a capacity of 10 L equipped with a nitrogen introducing tube, a dehydration tube, an agitator, and a thermocouple, and dissolved by heating to 160° C. The bi-reactive monomer, the polymerization initiator, and the raw material monomers of the vinyl-based polymer shown in Table 1 were added dropwise thereto from a dropping funnel over 1 hour while retaining the system to 160±3° C. Subsequently, the agitation was continued for 1 hour while retaining the system to 160±3° ° C. to polymerize the raw material monomers of the vinyl-based polymer and acrylic acid. Thereafter, the agitation was continued at 8.3 kPa for 1 hour to remove the unreacted monomers of the raw material monomers of the vinyl-based polymer. Thereafter, the esterification catalyst and the esterification promoter were added to the system, which was heated to 235° C. and reacted under ordinary pressure for 8 hours, and the reaction was continued at 8.3 kPa until the softening point reached the value shown in Table 1. The reaction product was cooled, solidified, and crushed to provide a composite resin A-1.

### Production Example 2

### (Production of Composite Resin A-2)

The alcohol components and the carboxylic acid components except for trimellitic acid shown in Table 1 were placed in a four-neck flask having a capacity of 10 L equipped with a nitrogen introducing tube, a dehydration tube, an agitator, and a thermocouple, and dissolved by heating to 160° C. The bi-reactive monomer, the polymerization initiator, and the raw material monomers of the vinyl-based polymer shown in Table 1 were added dropwise thereto from a dropping funnel over 1 hour while retaining the system to 160±3° C. The agitation was continued for 1 hour while retaining the system to 160° C. to polymerize the raw material monomers of the vinyl-based polymer unit and the bi-reactive monomer. Thereafter, the agitation was continued at 8.3 kPa for 1 hour to remove the unreacted monomers. Thereafter, the esterification catalyst was added to the system, which was heated to 230° C. and after retaining for 6.5 hours, reacted under reduced pressure of 8.3 kPa for 1 hour while retaining at 230° C. Thereafter, trimellitic acid was added at 215° C., and the reaction was continued at 210° C. and 40 kPa until the softening point reached the target value. The reaction product was cooled, solidified, and crushed to provide a composite resin A-2.

### Production Examples 3 and 4

### (Production of Composite Resins A-3 and A-4)

The composite resins A-3 and A-4 were obtained in the same manner as in Production Example 2 except that the raw material monomers shown in Table 1 were used.

### Production Example 5

### (Production of Composite Resin AA-1)

The alcohol monomers, the acid monomer, tin(II) di(2-ethylhexanoate), and gallic acid shown in Table 1 were mixed, heated to 235° C., reacted under ordinary pressure for 10 hours, and then reacted at 8.3 pKa until the softening point reached the target value. The reaction product was cooled, solidified, and crushed to provide a composite resin AA-1.

TABLE 1

| | | | Production Example | | | | | |
|---|---|---|---|---|---|---|---|---|
| | | | 1 | | 2 | | 3 | |
| | | | Resin | | | | | |
| | | | A-1 | | A-2 | | A-3 | |
| | | | Charged | Molar | Charged | Molar | Charged | Molar |
| | | | amount (g) | ratio *4 | amount (g) | ratio *4 | amount (g) | ratio *4 |
| Polyester resin | Alcohol | BPA-PO adduct *1 | 4185 | 70 | 4089 | 70 | 4654 | 100 |
| | component | BPA-EO adduct *2 | 1665 | 30 | 1627 | 30 | 0 | 0 |
| | Carboxylic | Terephthalic acid | 2552 | 90 | 1274 | 46 | 1700 | 77 |
| | acid | Fumaric acid | 0 | 0 | 0 | 0 | 0 | 0 |
| | component | Alkenylsuccinic anhydride *3 | 0 | 0 | 769 | 18 | 0 | 0 |
| | | Trimellitic acid | 0 | 0 | 705 | 22 | 255 | 10 |
| Bi-reactive monomer | | Acrylic acid | 98 | 8 | 36 | 3 | 48 | 5 |
| Vinyl based polymer | Raw material | Styrene | 1294 | 12.4 | 1102 | 10.6 | 1448 | 13.9 |
| | monomer | 2-Ethylhexyl acrylate | 0 | 0 | 210 | 1.1 | 621 | 3.4 |
| | | Stearyl methacrylate | 0 | 0 | 0 | 0 | 0 | 0 |
| | Radical | Di-tert-butyl peroxide | 103 | 0.7 | 105 | 0.7 | 124 | 0.9 |
| | polymerization | | | | | | | |
| | initiator | | | | | | | |

| Polyester resin/vinyl based polymer (mass ratio) | | 85/15 | | 85/15 | | 75/25 | |
|---|---|---|---|---|---|---|---|
| | | Charged | Molar | Charged | Molar | Charged | Molar |
| | | amount (g) | ratio *5 | amount (g) | ratio *5 | amount (g) | ratio *5 |
| Wax | Paracohol 6490 | 0 | 0 | 0 | 0 | 374 | 1 |
| | Fischer-Tropsch wax H105 | 0 | 0 | 0 | 0 | 561 | 6 |
| Esterification catalyst | Tin(II) di(2-ethylhexanoate) | 42 | 0.5 | 25 | 0.3 | 33 | 0.5 |
| Esterification promoter | Gallic acid | 4.2 | 0.05 | 0 | 0 | 3.3 | 0.05 |
| Radical polymerization | 4-tert-butylcatechol | 0 | 0 | 0 | 0 | 0 | 0 |
| inhibitor | | | | | | | |

| | | | | |
|---|---|---|---|---|
| Properties | Softening point Tm (° C.) | 125 | 112 | 97 |
| | Glass transition point Tg (° C.) | 63 | 60 | 50 |
| | Acid value (mgKOH/g) | 22 | 24 | 16 |
| | Hydroxyl value (mgKOH/g) | 32 | 28 | 23 |
| | Number average molecular weight Mn | 3,600 | 2,360 | 2,600 |
| | Weight average molecular weight Mw | 51,000 | 46,200 | 43,000 |
| | Polydispersity Mw/Mn | 14.2 | 19.6 | 16.5 |
| | SP value of polyester part | 11.1 | 10.8 | 10.8 |
| | SP value of vinyl polymer part | 10.3 | 10.0 | 9.8 |
| | SP value of entire resin | 10.9 | 10.7 | 10.5 |
| | Tg of vinyl polymer part (° C.) | 45 | 65 | 47 |

| | | | Production Example | | | |
|---|---|---|---|---|---|---|
| | | | 4 | | 5 | |
| | | | Resin | | | |
| | | | A-4 | | AA-1 | |
| | | | Charged | Molar | Charged | Molar |
| | | | amount (g) | ratio *4 | amount (g) | ratio *4 |
| Polyester resin | Alcohol | BPA-PO adduct *1 | 3876 | 100 | 4898 | 70 |
| | component | BPA-EO adduct *2 | 0 | 0 | 1949 | 30 |
| | Carboxylic | Terephthalic acid | 1193 | 65 | 3153 | 95 |
| | acid | Fumaric acid | 154 | 12 | 0 | 0 |
| | component | Alkenylsuccinic anhydride *3 | 0 | 0 | 0 | 0 |
| | | Trimellitic acid | 255 | 12 | 0 | 0 |
| Bi-reactive monomer | | Acrylic acid | 127 | 16 | 0 | 0 |
| Vinyl based polymer | Raw material | Styrene | 2654 | 25.5 | 0 | 0 |
| | monomer | 2-Ethylhexyl acrylate | 0 | 0 | 0 | 0 |
| | | Stearyl methacrylate | 664 | 2 | 0 | 0 |
| | Radical | Di-tert-butyl peroxide | 398 | 2.7 | 0 | 0 |
| | polymerization | | | | | |
| | initiator | | | | | |

| Polyester resin/vinyl based polymer (mass ratio) | | 60/40 | | 100/0 | |
|---|---|---|---|---|---|
| | | Charged | Molar | Charged | Molar |
| | | amount (g) | ratio *5 | amount (g) | ratio *5 |
| Wax | Paracohol 6490 | 371 | 4 | 0 | 0 |
| | Fischer-Tropsch wax H105 | 0 | 0 | 0 | 0 |
| Esterification catalyst | Tin(II) di(2-ethylhexanoate) | 28 | 0.5 | 50 | 0.5 |
| Esterification promoter | Gallic acid | 1.7 | 0.03 | 5.0 | 0.05 |
| Radical polymerization | 4-tert-butylcatechol | 1.1 | 0.02 | 0 | 0 |
| inhibitor | | | | | |

| | | | |
|---|---|---|---|
| Properties | Softening point Tm (° C.) | 122 | 110 |
| | Glass transition point Tg (° C.) | 52 | 64 |
| | Acid value (mgKOH/g) | 20 | 4 |
| | Hydroxyl value (mgKOH/g) | 11 | 20 |
| | Number average molecular weight Mn | 2,290 | 4,130 |
| | Weight average molecular weight Mw | 26,700 | 15,300 |
| | Polydispersity Mw/Mn | 11.7 | 3.7 |
| | SP value of polyester part | 10.9 | 11.2 |
| | SP value of vinyl polymer part | 9.7 | — |
| | SP value of entire resin | 10.4 | 11.2 |
| | Tg of vinyl polymer part (° C.) | 43 | — |

*1: BPA-PO: polyoxypropylene (2.2) adduct of bisphenol A
*2: BPA-EO: polyoxyethylene (2.2) adduct of bisphenol A
*3: Alkenylsuccinic anhydride: Dodecenyl Succinic Anhydride, Crude (DDSA-C), available from Milliken & Company
*4: Molar ratio of raw material monomer per 100 parts by mol of alcohol component of raw material monomer of polyester
*5: Wax component: percentage by mass based on total amount of raw material monomers
Esterification catalyst, esterification promoter, radical polymerization inhibitor: percentage by mass based on total of raw material monomer of polyester resin

The wax components used were as follows.

Paracohol 6490: available from Nippon Seiro Co., Ltd., number average molecular weight: 800, melting point: 76° C., acid value: 18 mgKOH/g, hydroxyl value: 97 mgKOH/g

Fischer-Tropsch wax H105: available from Sasol Wax GmbH, melting point: 105° ° C.

### Example 1-1

200 g of neat asphalt (Performance Grade (PG) 64-22, available from Associated Asphalt, Inc.) heated to 180° C. in advance was weighed in a 300 mL stainless steel beaker, to which 10 g of the composite resin A-1 obtained in Production Example 1 was added (5 parts by mass per 100 parts by mass of the asphalt), and the mixture was agitated at 180° ° C. at an agitation speed of 400 rpm for 2 hours, so as to prepare an asphalt composition (AS-1).

### Examples 1-2 to 1-4 and Comparative Examples 1-1 to 1-3

Asphalt compositions AS-2 to AS-4 and AS-C1 to AS-C3 were prepared in the same manner as in Example 1-1 except that the formulation was changed as shown in Table 2.

In Comparative Example 1-3, the asphalt used was modified asphalt (Performance Grade (PG) 76-22, available from Ergon Asphalt & Emulsions, Inc.).

### [Evaluation]

### [Storage Stability Test]

100 g of the asphalt composition prepared above was weighed in each of two glass bottles having a capacity of 4 oz (available from Piramal Glass USA, Inc., trade name: Piramal Glass). The asphalt composition was stored in an oven at 180° C. for 18 hours, and then cooled to room temperature. The height of the deposit of the composite resin in the asphalt composition was visually measured, and the measured deposit amount of the composite resin was designated as the index of the storage stability. A smaller deposit amount of the composite resin shows better storage stability of the asphalt composition. An asphalt composition excellent in storage stability applied to pavement shows less variability in asphalt strength. The results are shown in Table 2.

TABLE 2

| | | | Composite resin | | Evalua- |
|---|---|---|---|---|---|
| | Asphalt | Asphalt | | Content *1 | tion |
| | com- | PG grade | | (part by | Storage |
| | position | Type | Kind | mass) | stability |
| Example 1-1 | AS-1 | PG64-22 | A-1 | 5 | 0.0 |
| Example 1-2 | AS-2 | PG64-22 | A-2 | 5 | 0.0 |
| Example 1-3 | AS-3 | PG64-22 | A-3 | 5 | 0.0 |
| Example 1-4 | AS-4 | PG64-22 | A-4 | 5 | 0.0 |
| Comparative | AS-C1 | PG64-22 | AA-1 | 5 | 3.0 |
| Example 1-1 | | | | | |
| Comparative | AS-C2 | PG64-22 | — | — | 0.0 |
| Example 1-2 | | | | | |
| Comparative | AS-C3 | PG76-22 | AA-1 | 5 | 1.8 |
| Example 1-3 | | | | | |

*1 Content (part by mass) per 100 parts by mass of asphalt

### Example 2-1

150 g of asphalt, 4.5 g of the composite resin A-1 obtained in Production Example 1, and 2,500 g of an aggregate were used. The aggregate was placed in a Hobart mixer and mixed at 180° C. for 30 seconds. Subsequently, the asphalt was added thereto, and the mixture was mixed for 1 minutes. The asphalt modifier was further added thereto, and the mixture was mixed for 1 minutes. The resulting asphalt mixture was stored at 180° C. for 15 minutes, and then 1,200 g of the mixture was charged in a formwork and molded by tamping 75 times for one side with an automatic asphalt tamping machine (trade name: NA-507, available from Nakajima Technology, Inc.), followed by gradually cooling to room temperature over 15 hours to provide an asphalt specimen.

### (Aggregate)

The aggregate used was an aggregate available from Blythe Construction, Inc. 2,500 g of the aggregate contained 625 g of ballast (coarse aggregate), 1,625 g of screenings (fine aggregate), and 250 g of pit sand (fine aggregate). The passing mass percentages of the components were as follows.

Passing mass percentage:

### [Ballast]

Sieve mesh 9.50 mm: 90.4% by mass
Sieve mesh 8.00 mm: 73.3% by mass
Sieve mesh 4.75 mm: 24.8% by mass
Sieve mesh 2.80 mm: 3.9% by mass
Sieve mesh 1.00 mm: 1.2% by mass
Sieve mesh 0.50 mm: 0.8% by mass

### [Screenings]

Sieve mesh 9.50 mm: 100.0% by mass
Sieve mesh 8.00 mm: 99.9% by mass
Sieve mesh 4.75 mm: 98.2% by mass
Sieve mesh 2.80 mm: 77.4% by mass
Sieve mesh 1.00 mm: 36.8% by mass
Sieve mesh 0.50 mm: 22.1% by mass

### [Pit Sand]

Sieve mesh 9.50 mm: 100.0% by mass
Sieve mesh 8.00 mm: 100.0% by mass
Sieve mesh 4.75 mm: 98.0% by mass
Sieve mesh 2.80 mm: 94.2% by mass
Sieve mesh 1.00 mm: 70.6% by mass
Sieve mesh 0.50 mm: 33.6% by mass

### Examples 2-2 to 2-4 and Comparative Examples 2-1 and 2-2

Asphalt specimens were prepared in the same manner as in Example 2-1 except that the formulation was changed as shown in Table 3.

### [Evaluation]

### [Measurement Method of Void Ratio]

The asphalt mixture before compaction was measured for the theoretical density Gmm according to AASHTO T209 of American Association of State Highway and Transportation Officials (AASHTO). The asphalt mixture was compacted with an automatic asphalt compaction machine according to AASHTO T166 to provide an asphalt specimen. The bulk density Gmb of the asphalt specimen was calculated according to the following expression. In the expression, D represents the weight (g) of the specimen in a dry state, W represents the weight (g) of the specimen on immersion in water, and S represents the weight (g) of the specimen after immersing in water and then wiping water drops on the surface.

Gmb=D/(S−W)

The air voids ratio Va (% by weight) was obtained from Gmm and Gmb obtained above according to the following expression. The average value and the standard deviation of the results of three tests are shown in Table 3.

$$Va = ( 1 - ( Gmb / Gmm ) ) \times 100$$

### [Evaluation Method of Oil Resistance of Asphalt Specimen]

An asphalt specimen was immersed in kerosene (available from Speedway LLC) for 2 minutes. The container for immersion was a 1-gallon round can for oily substances, and a pedestal formed of metal mesh in an approximately 7 cm square shape with 1 cm in height was placed on the bottom of the can, with which all the surfaces of the specimen were well immersed in kerosene. After immersion for 2 minutes, the specimen was taken out, and after wiping off kerosene on the surface thereof, the weight thereof was measured. The weight at this time was designated as Wa.

After the measurement of the weight, the specimen was again immersed in kerosene for 24 hours. After 24 hours, the specimen was taken out, and after wiping off the kerosene on the surface thereof with paper towel, was dried at room temperature (20° C.) in an air atmosphere for 24 hours, and then the weight thereof was again measured. The weight at this time was designated as Wb. The weight loss factor as the index of the fuel resistance was determined according to the following expression. The average value and the standard deviation of the results of three tests are shown in Table 3.

$$Weight loss factor ( \% ) = ( ( Wa - W b ) / Wa ) \times 100$$

A smaller weight loss factor means better fuel resistance of the asphalt specimen.

The fuel resistance was evaluated as the index of the strength, particularly the strength unevenness, of the asphalt specimen.

Known evaluation methods for fuel resistance include the method according to FAA P-404 by Federal Aviation Administration (FAA) for fuel resistant asphalt pavements for airports. In this standard, the air voids ratio is 2.5±0.2% by weight.

On the other hand, the dense graded asphalt for general roads generally has and air voids ratio of 7.5±0.5% by weight. The evaluation results in the examples correspond to the dense graded asphalt for general roads.

In the examples, the asphalt specimen having a void ratio of 7.5±0.5% by weight, which was higher than the standard of FAA P-404, was used, and the fuel resistance was evaluated under the severer condition.

TABLE 3

| | | Aggregate | Asphalt | Composite resin | | Evaluation | |
|---|---|---|---|---|---|---|---|
| | Asphalt | Content *1 | PG grade | | Content *1 | Air Voids | Weight Loss |
| | specimen | (part by mass) | Type | Kind | (part by mass) | ratio | (wt. %) |
| Example 2-1 | M-1 | 1667 | PG64-22 | A-1 | 3 | 7.2 ± 0.14 | 2.1 ± 0.22 |
| Example 2-2 | M-2 | 1667 | PG64-22 | A-2 | 3 | 7.2 ± 0.24 | 1.3 ± 0.13 |
| Example 2-3 | M-3 | 1667 | PG64-22 | A-3 | 3 | 6.6 ± 0.19 | 1.5 ± 0.09 |
| Example 2-4 | M-4 | 1667 | PG64-22 | A-4 | 3 | 7.2 ± 0.12 | 1.9 ± 0.08 |
| Comparative | M-C2 | 1667 | PG64-22 | — | — | 7.0 ± 0.12 | 3.0 ± 0.17 |
| Example 2-1 | | | | | | | |
| Comparative | M-C3 | 1667 | PG76-22 | AA-1 | 3 | 7.0 ± 0.19 | 2.8 ± 0.26 |
| Example 2-2 | | | | | | | |

*1: Content (part by mass) per 100 parts by mass of asphalt

It is understood from the comparison between Examples and Comparative Examples that the asphalt compositions using the particular composite resin in Examples show excellent storage stability at a high temperature as compared to the asphalt compositions of Comparative Examples, and in the application to road pavements, can provide a pavement body with less variability in strength. Furthermore, the asphalt specimens obtained from the asphalt mixtures using the particular composite resin in Examples show excellent fuel resistance (low weight loss) and can provide a pavement body with less variability in strength.

1. An asphalt composition comprising asphalt (A) and a composite resin (B),
wherein the composite resin (B) contains a polyester resin (b1) unit and a vinyl-based polymer (b2) unit bonded via a covalent bond,
wherein the polyester resin (b1) unit contains a structural unit derived from an alcohol component and a structural unit derived from a carboxylic acid component,
and the vinyl-based polymer (b2) unit contains a structural unit derived from styrene.

2. The asphalt composition according to claim 1, wherein the alcohol component contains an alkylene oxide adduct of bisphenol A.

3. The asphalt composition according to claim 1, wherein the carboxylic acid component contains an aromatic dicarboxylic acid.

4. The asphalt composition according to claim 1, wherein the carboxylic acid component contains succinic acid substituted by an alkenyl group having 2 to 20 carbon atoms.

5. The asphalt composition according to claim 1, wherein the vinyl-based polymer (b2) further contains a structural unit derived from an alkyl (meth)acrylate having an alkyl group having 4 to 22 carbon atoms.

6. The asphalt composition according to claim 1, wherein the composite resin (B) has a molar ratio of the vinyl-based polymer (b2) unit to the polyester resin (b1) unit ((b2)/(b1)) in a range of 10/90 to 45/55.

7. The asphalt composition according to claim 1, wherein the vinyl-based polymer (b2) has a SP value of 9.5 to 10.5.

8. The asphalt composition according to claim 1, wherein the composite resin (B) has a glass transition temperature of 40° ° C. to 100° C.

9. The asphalt composition according to claim 1, wherein the composite resin (B) has a polydispersity (Mw/Mn) of 4 to 25.

10. The asphalt composition according to claim 1, wherein the composite resin (B) has a hydroxyl value of 10 mgKOH/g to 35 mgKOH/g.

11. The asphalt composition according to claim 1, wherein the composite resin (B) has a softening point of 95° C. to 130° C.

12. The asphalt composition according to claim 1, wherein the asphalt composition has a content of the asphalt (A) of 85 wt. % to 99.5 wt. %.

13. The asphalt composition according to claim 1, wherein the asphalt composition has a content of the composite resin (B) of 0.5 wt. % to 15 wt. %.

14. The asphalt composition according to claim 1, wherein the asphalt (A) has a content of a thermoplastic elastomer of ≤1 wt. %.

15. An asphalt mixture comprising the asphalt composition according to claim 1 and an aggregate.

16. A production method of an asphalt mixture comprising,
mixing asphalt (A) and composite resin (B) to obtain an asphalt composition, and
mixing the asphalt composition and a heated aggregate,
wherein the composite resin (B) contains a polyester resin (b1) unit and a vinyl-based polymer (b2) unit bonded via a covalent bond,
wherein the polyester resin (b1) unit contains a structural unit derived from an alcohol component and a structural unit derived from a carboxylic acid component,
and the vinyl-based polymer (b2) unit contains a structural unit derived from styrene.

17. A road pavement method comprising a step of laying down the asphalt mixture according to claim 15 on the road to form an asphalt pavement material layer.
